(19) United States
(12) Patent Application Publication
(10) Pub. No.: US 2025/0125483 A1
(43) Pub. Date: Apr. 17, 2025

(54) LAMINATED CELL

(71) Applicant: TOYOTA JIDOSHA KABUSHIKI KAISHA, Toyota-shi (JP)

(72) Inventor: Takuya MATSUYAMA, Toyota-shi (JP)

(73) Assignee: TOYOTA JIDOSHA KABUSHIKI KAISHA, Toyota-shi (JP)

(21) Appl. No.: 18/904,089

(22) Filed: Oct. 2, 2024

(30) Foreign Application Priority Data
Oct. 12, 2023 (JP) 2023-176742

(51) Int. Cl. H01M 50/392; H01M 10/0562

(52) U.S. Cl. CPC H01M 50/392; H01M 10/0562; H01M 2300/0068

(57) ABSTRACT

A laminated cell of the present disclosure includes: one or more cells each including an electrode stack and a laminated film that seals the electrode stack; and an exterior material sealing the one or more cells. The electrode stack in the laminated cell of the present disclosure includes a sulfide solid electrolyte, and a space between the laminated film and the exterior material is depressurized and/or filled with an inert gas.

### CROSS-REFERENCE TO RELATED APPLICATION

This application claims priority to Japanese Patent Application No. 2023-176742 filed on Oct. 12, 2023, incorporated herein by reference in its entirety.

### BACKGROUND

### 1. Technical Field

The present disclosure relates to laminated cells.

### 2. Description of Related Art

Secondary cells such as lithium-ion secondary cells are lightweight and have a high energy density. Secondary cells are widely used for portable power supplies for personal computers and mobile terminals and driving power supplies for vehicles such as battery electric vehicles (EVs), hybrid electric vehicles (HVs), and plug-in hybrid electric vehicles (PHVs). One form of such a secondary cell used for driving power supplies for vehicles is a so-called laminated cell having a structure in which an electrode stack is sealed with an exterior material made of a laminated film.

For example, Japanese Unexamined Patent Application Publication No. 2021-176134 (JP 2021-176134 A) discloses an all-solid-state cell in which a battery cell is enclosed in a laminated film.

Japanese Unexamined Patent Application Publication No. 2020-170583 (JP 2020-170583 A) discloses a laminated secondary cell including a laminated exterior material having a double structure.

### SUMMARY

Solid cells containing a sulfide solid electrolyte are known in the art. The solid cells may generate hydrogen sulfide gas due to, for example, overcharging. For example, high-temperature hydrogen sulfide gas generated in a laminated cell may open a sealed portion of the laminated film and leak from inside the cell.

An object of the present disclosure is to provide a laminated cell that can reduce leakage of high-temperature hydrogen sulfide gas from inside the cell.

The disclosers found that the above issue can be resolved by the following means.

### First Aspect

A laminated cell includes: one or more cells each including an electrode stack and a laminated film that seals the electrode stack; and an exterior material sealing the one or more cells. The electrode stack includes a sulfide solid electrolyte. A space between the laminated film and the exterior material is depressurized and filled with an inert gas, or is either depressurized or filled with the inert gas.

### Second Aspect

In the laminated cell according to the first aspect, the exterior material may be a laminated film.

### Third Aspect

In the laminated cell according to the second aspect, sealing strength of a specific sealed portion of the laminated film as the exterior material may be lower than sealing strength of another sealed portion of the laminated film.

The laminated cell of the present disclosure can reduce leakage of high-temperature hydrogen sulfide gas from inside the cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a laminated cell of the present disclosure; and

FIG. 2 is a schematic diagram illustrating an example of a laminated cell of the present disclosure.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Laminated Cell

A laminated cell of the present disclosure includes: one or more cells each including an electrode stack and a laminated film that seals the electrode stack; and an exterior material sealing the one or more cells. The electrode stack in the laminated cell of the present disclosure includes a sulfide solid electrolyte, and a space between the laminated film and the exterior material is depressurized and/or filled with an inert gas.

The disclosers further seal a cell sealed with a laminated film with an exterior material so that a space between the laminated film and the exterior material is depressurized and/or filled with an inert gas. As a result, it was found that the high-temperature hydrogen sulfide gas hardly leaks from inside the cell. The reason for this is that if high-temperature hydrogen sulfide gas leaks out of the laminated film from inside the cell, the hydrogen sulfide gas is cooled while it fills the space between the laminated film and the exterior material where there is substantially no oxygen. As a result, when the hydrogen sulfide gas leaks from inside the space to outside the exterior material, it is considered that the hydrogen sulfide gas has a temperature lower than a predetermined value.

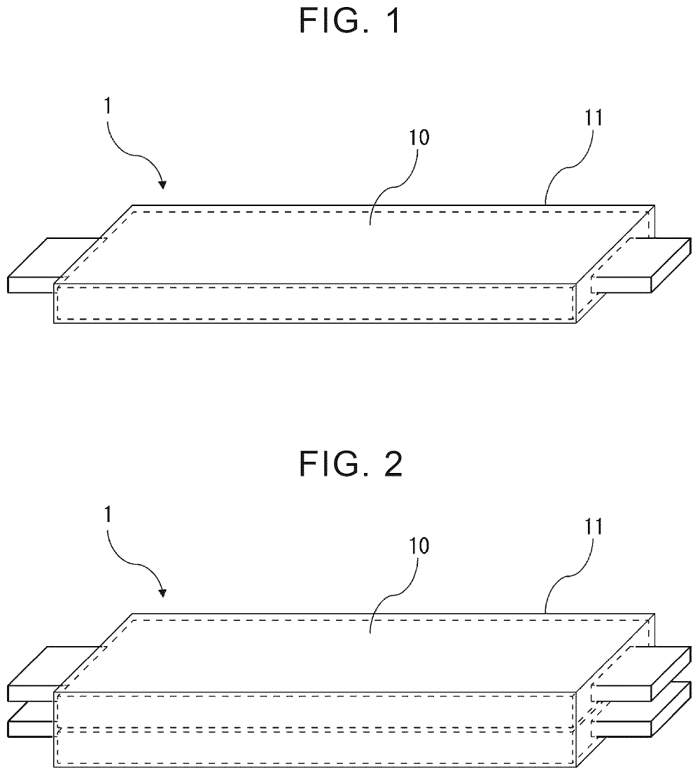

Hereinafter, the laminated cell 1 of the present disclosure will be described with reference to the drawings. FIGS. 1 and 2 are schematic diagrams showing an example of a laminated cell 1 of the present disclosure. The dimensional relationship in FIGS. 1 and 2 does not reflect the actual dimensional relationship.

The laminated cell 1 of the present disclosure includes: one or more cells each including an electrode stack and a laminated film 10 that seals the electrode stack; and an exterior material sealing the one or more cells.

When the high-temperature hydrogen sulfide gas is released, it is assumed that the heat transfer is accelerated as the number of batteries increases. In the present disclosure, as shown in FIG. 2, a configuration in which a plurality of batteries is sealed with the exterior material 11 can be adopted, and by adopting such a configuration, heat transfer can be effectively suppressed. Although FIG. 2 shows the laminated cell 1 of the present disclosure composed of two cells, the number of cells is not limited to this.

The exterior material 11 is not particularly limited as long as it can seal a cell. For example, the exterior material 11 may be a laminated film or an exterior case.

The electrode stack includes a sulfide solid electrolyte. For example, hydrogen sulfide gas may be generated from a sulfide solid electrolyte by overcharging the cell.

Examples of sulfide solid electrolytes include, but are not limited to, sulfide amorphous solid electrolytes, sulfide crystalline solid electrolytes, or argyrodite-type solid electrolytes. Specific examples of the sulfide solid electrolyte include Li₂S—P₂S₅-based electrolytes (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, and Li₇₋ₓPS₆₋ₓClₓ. Examples of the sulfide solid electrolyte include, but are not limited to, combinations thereof.

The sulfide solid electrolyte may be glass or crystallized glass (glass ceramic).

In the laminated cell 1 of the present disclosure, the space between the laminated film 10 and the exterior material 11 is depressurized and/or filled with an inert gas. With such a configuration, oxygen is substantially not present in the space between the laminated film 10 and the exterior material 11. Even if the high-temperature hydrogen sulfide gas flows into the space, the hydrogen sulfide gas is cooled while filling the space, and the temperature when the hydrogen sulfide gas leaks to the outside of the exterior material can be lowered. Examples of the inert gas include nitrogen, argon and the like.

The volume of the space between the laminated film 10 and the exterior material 11 is not particularly limited as long as it can cool the hydrogen sulfide gas.

In the laminated cell 1 of the present disclosure, the sealing strength of a specific sealed portion of the laminated film as the exterior material 11 may be lower than the sealing strength of another sealed portion of the laminated film. With such a configuration, the direction in which the hydrogen sulfide gas leaks can be controlled. For example, the laminated cell 1 of the present disclosure may be mounted on a vehicle, and in this case, by adjusting the position of the specific sealed portion, the hydrogen sulfide gas can be controlled to be discharged to the outside of the vehicle cabin.

### Comparative Example 1

A laminated film was wound around the electrode stack containing the sulfide solid electrolyte, and the space between the electrode stack and the laminated film was depressurized to vacuum and sealed, thereby obtaining a cell of Comparative Example 1.

### Example 1

A laminated film was wound around an electrode stack including a sulfide solid electrolyte, and the space between the electrode stack and the laminated film was depressurized to vacuum and sealed. Further, a laminated film as an exterior material was wound around the resultant member, and the space between the inner laminated film and the outer laminated film as an exterior material was depressurized to vacuum and sealed. A laminated cell of Example 1 was thus obtained.

### Evaluation

The cell of the comparative example was charged by continuously flowing a current at a 5.5 C until high-temperature hydrogen sulfide gas leaked from inside the cell. The laminated cell of the example was charged under the same conditions.

### Results

In the laminated cell of the example, even when the cell was charged under the same conditions as in the comparative example, no leakage of the high-temperature hydrogen sulfide gas from inside the cell was confirmed.

What is claimed is:

1. A laminated cell comprising:
one or more cells each including an electrode stack and a laminated film that seals the electrode stack; and
an exterior material sealing the one or more cells, wherein
the electrode stack includes a sulfide solid electrolyte, and
a space between the laminated film and the exterior material is depressurized and filled with an inert gas, or is either depressurized or filled with the inert gas.

2. The laminated cell according to claim 1, wherein the exterior material is a laminated film.

3. The laminated cell according to claim 2, wherein sealing strength of a specific sealed portion of the laminated film as the exterior material is lower than sealing strength of another sealed portion of the laminated film.
